(19) United States
(12) Patent Application Publication
(10) Pub. No.: US 2008/0023885 A1
(43) Pub. Date: Jan. 31, 2008

(54) METHOD FOR FORMING A NANO-IMPRINT LITHOGRAPHY TEMPLATE HAVING VERY HIGH FEATURE COUNTS

(75) Inventor: Yevgeny Vasilievich Anoikin, Fremont, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 11/553,443

(22) Filed: Oct. 26, 2006

Related U.S. Application Data
(60) Provisional application No. 60/814,022, filed on Jun. 15, 2006.

(51) Int. Cl. B29C 59/16

(52) U.S. Cl. 264/446

(57) ABSTRACT

An embodiment of a method for forming a nano-imprint lithography template having very high feature counts includes exposing a sub-template using electron beam lithography, the sub-template including a fraction of the template, transferring a first pattern from the sub-template to the template using nano-imprinting lithography, repositioning the sub-template, and transferring a second pattern from the sub-template to the template using nano-imprinting lithography, wherein the template includes the first pattern and the second pattern.

### PRIORITY CLAIM

This application claims priority to the following U.S. Provisional Patent Application:

U.S. Provisional Patent Application No. 60/814,022, entitled “Method for Forming a Nano-Imprint Lithography Template Having Very High Feature Counts,” by Yevgeny Vasilievich Anoikin, filed Jun. 15, 2006, Attorney Docket No. NANO-01042US0.

### CROSS-REFERENCE TO RELATED PATENT APPLICATIONS

This application incorporates by reference all of the following co-pending applications and the following issued patents:

U.S. patent application Ser. No. 11/177,250, entitled “Media for Writing Highly Resolved Domains,” by Yevgeny V. Anoikin et al., filed Jul. 8, 2005, Attorney Docket No. NANO-01032US1;

U.S. patent application Ser. No. 11/177,639, entitled “Patterned Media for a High Density Data Storage Device,” by Zhaohui Fan et al., filed Jul. 8, 2005, Attorney Docket No. NANO-01033US0;

U.S. patent application Ser. No. 11/177,062, entitled “Method for Forming Patterned Media for a High Density Data Storage Device,” by Zhaouhi Fan et al, filed Jul. 8, 2005, Attorney Docket No. NANO-01033US1;

U.S. patent application Ser. No. 11/177,599, entitled “High Density Data Storage Devices with Read/Write Probes with Hollow or Reinforced Tips,” by Nickolai Belov, filed Jul. 8, 2005, Attorney Docket No. NANO-01034US0;

U.S. patent application Ser. No. 11/177,731, entitled “Methods for Forming High Density Data Storage Devices with Read/Write Probes with Hollow or Reinforced Tips,” by Nickolai Belov, filed Jul. 8, 2005, Attorney Docket No. NANO-01034US1;

U.S. patent application Ser. No. 11/177,642, entitled “High Density Data Storage Devices with Polarity-Dependent Memory Switching Media,” by Donald E. Adams, et al., filed Jul. 8, 2005, Attorney Docket No. NANO-01035US0;

U.S. patent application Ser. No. 11/178,060, entitled “Methods for Writing and Reading in a Polarity-Dependent Memory Switching Media,” by Donald E. Adams, et al., filed Jul. 8, 2005, Attorney Docket No. NANO-01035US1;

U.S. patent application Ser. No. 11/178,061, entitled “High Density Data Storage Devices with a Lubricant Layer Comprised of a Field of Polymer Chains,” by Yevgeny V. Anoikin, filed Jul. 8, 2005, Attorney Docket No. NANO-01036US0;

U.S. patent application Ser. No. 11/004,153, entitled “Methods for Writing and Reading Highly Resolved Domains for High Density Data Storage,” by Thomas F. Rust et al, filed Dec. 3, 2004, Attorney Docket No. NANO-01024US1;

U.S. patent application Ser. No. 11/003,953, entitled “Systems for Writing and Reading Highly Resolved Domains for High Density Data Storage,” by Thomas F. Rust et al, filed Dec. 3, 2004, Attorney Docket No. NANO-01024US2;

U.S. patent application Ser. No. 11/004,709, entitled “Methods for Erasing Bit Cells in a High Density Data Storage Device,” by Thomas F. Rust et al., filed Dec. 3, 2004, Attorney Docket No. NANO-01031US0;

U.S. patent application Ser. No. 11/003,541, entitled “High Density Data Storage Device Having Erasable Bit Cells,” by Thomas F. Rust et al., filed Dec. 3, 2004, Attorney Docket No. NANO-01031US1;

U.S. patent application Ser. No. 11/003,955, entitled “Methods for Erasing Bit Cells in a High Density Data Storage Device,” by Thomas F. Rust et al., filed Dec. 3, 2004, Attorney Docket No. NANO-01031US2;

U.S. Pat. No. 6,982,898, entitled “Molecular Memory Integrated Circuit Utilizing Non-Vibrating Cantilevers, Attorney Docket No. NANO-01011US1, issued Jan. 3, 2006 to Thomas F. Rust et al.;

U.S. patent application Ser. No. 10/684,661, entitled “Atomic Probes and Media for high Density Data Storage,” by Thomas F. Rust et al., filed Oct. 14, 2003, Attorney Docket No. NANO-01014US1;

U.S. patent application Ser. No. 11/321,136, entitled “Atomic Probes and Media for High Sensity Data Storage,” by Thomas F. Rust, filed Dec. 29, 2005, Attorney Docket No. NANO-1014US2;

U.S. patent application Ser. No. 10/684,760, entitled “Fault Tolerant Micro-Electro Mechanical Actuators,” by Thomas F. Rust, filed Oct. 14, 2003, Attorney Docket No. NANO-01015US1;

U.S. Pat. No. 6,985,377, entitled “Phase Change Media for High Density Data Storage,” Attorney Docket No. NANO-01019US1, issued Jan. 10, 2006 to Thomas F. Rust et al.;

U.S. patent application Ser. No. 09/435,592, entitled “Molecular Memory Medium and Molecular Memory Integrated Circuit,” by Joanne P. Culver, filed Dec. 17, 1999, Attorney Docket No. NANO-01000US0;

U.S. Pat. No. 5,453,970, entitled “Molecular Memory Medium and Molecular Memory Disk Drive for Storing Information Using a Tunnelling Probe,” issued Sep. 26, 1995 to Thomas F. Rust, et al.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to high density data storage and transferring patterns having very high feature density.

### BACKGROUND

Software developers continue to develop steadily more data intensive products, such as ever-more sophisticated, and graphic intensive applications and operating systems (OS). Each generation of application or OS always seems to earn the derisive label in computing circles of being “a memory hog.” Higher capacity data storage, both volatile and non-volatile, has been in persistent demand for storing code for such applications. Add to this need for capacity, the confluence of personal computing and consumer electronics in the form of personal MP3 players, such as the iPod, personal digital assistants (PDAs), sophisticated mobile phones, and laptop computers, which has placed a premium on compactness and reliability.

Nearly every personal computer and server in use today contains one or more hard disk drives for permanently storing frequently accessed data. Every mainframe and supercomputer is connected to hundreds of hard disk drives. Consumer electronic goods ranging from camcorders to TiVo® use hard disk drives. While hard disk drives store large amounts of data, they consume a great deal of power, require long access times, and require “spin-up” time on power-up. FLASH memory is a more readily accessible form of data storage and a solid-state solution to the lag time and high power consumption problems inherent in hard disk drives. Like hard disk drives, FLASH memory can store data in a non-volatile fashion, but the cost per megabyte is dramatically higher than the cost per megabyte of an equivalent amount of space on a hard disk drive, and is therefore sparingly used.

Phase change media are used in the data storage industry as an alternative to traditional recording devices such as magnetic recorders (tape recorders and hard disk drives) and solid state transistors (EEPROM and FLASH). CD-RW data storage discs and recording drives use phase change technology to enable write-erase capability on a compact disc-style media format. CD-RWs take advantage of changes in optical properties (e.g., reflectivity) when phase change material is heated to induce a phase change from a crystalline state to an amorphous state. A “bit” is read when the phase change material subsequently passes under a laser, the reflection of which is dependent on the optical properties of the material. Unfortunately, current technology is limited by the wavelength of the laser, and does not enable the very high densities required for use in today's high capacity portable electronics and tomorrow's next generation technology such as systems-on-a-chip and micro-electric mechanical systems (MEMS). Consequently, there is a need for solutions which permit higher density data storage.

### BRIEF DESCRIPTION OF THE DRAWINGS

Further details of the present invention are explained with the help of the attached drawings in which:

FIGS. 1A and 1B are exemplary patterned media devices for use in probe storage devices having a recording media comprising a phase change material.

FIGS. 2A and 2B are exemplary patterned media devices for use in probe storage devices having a recording media comprising a polarity dependent material.

FIG. 3 is a flowchart illustrating an embodiment of a method in accordance with the present invention.

### DETAILED DESCRIPTION

Probe storage devices enabling higher density data storage (relative to current technology) can include cantilevers with contact probe tips as components. Such probe storage devices typically use two parallel plates. A first plate includes the cantilevers with contact probe tips extending therefrom for use as read-write heads and a second, complementary plate includes a media device for storing data. At least one of the plates can be moved with respect to the other plate in a lateral X-Y plane while maintaining satisfactory control of the Z-spacing between the plates. Motion of the plates with respect to each other allows scanning of the media device by the contact probe tips and data transfer between the contact probe tips and the media device.

In some probe storage devices, for example utilizing phase change materials as recording media in a stack of the media device, both mechanical and electrical contact between the contact probe tips and the media device enables data transfer. In order to write data to the media device, current is passed through the contact probe tips and the recording media to induce a change in a property of a portion of the recording media. For example, where the recording media is a phase change material, current passed through the contact probe tips and the phase change material can generate heat sufficient to cause a phase-change in some portion of the phase change material. Alternatively, where the recording media is a polarity-dependent material, current passed through the contact probe tips and the polarity-dependent material can alter the electrical resistance (and therefore the electrical conductivity) of a portion of the polarity-dependent material. Electrical resistance of the recording media can vary depending on parameters of a write pulse, and therefore can represent data.

The memory device can comprise a stack of continuous layers. In such devices, electrical contact between the contact probe tips and the media device is controlled to limit shunting and to reduce a longitudinal space requirement of the portion for which the property of the recording media is changed to form an indicia. Alternatively, the memory device can comprise a stack including continuous layers and one or more discontinuous layers. Such media devices can be said to be a patterned media device having discrete memory cells for forming indicia. Use of a patterned media device can enable predefined servo and timing patterns and can potentially increase signal-to-noise ratio.

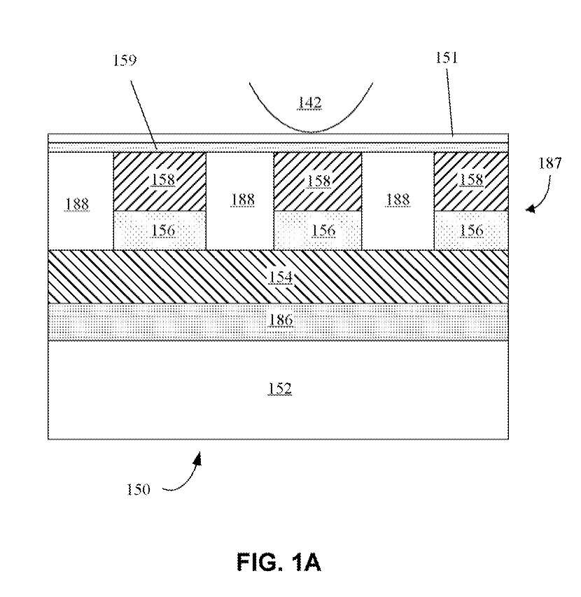

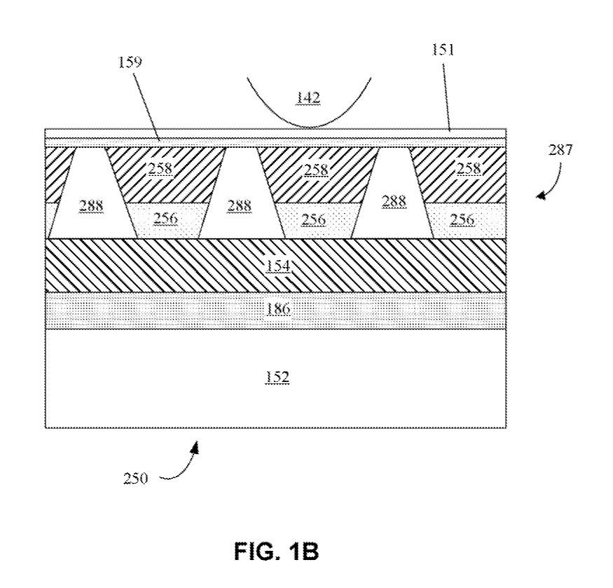

FIGS. 1A and 1B are cross-sections of exemplary patterned media devices for use with probe storage devices. Methods in accordance with embodiments of the present invention can be applied to define patterns of the patterned media devices. The media devices 150/250 include a substrate 152, an under-layer 154 disposed over the substrate 152, an optional insulating layer 186 disposed between the substrate 152 and the under-layer 154, a continuous or discontinuous layer of recording media 156/256 formed over the under-layer 154, a discontinuous over-layer 158/258 formed over the recording media 156/256, a lubricant 151 disposed over the surface of the media device 150/250, and optionally a lubricant adhesion layer 159 disposed between the lubricant 151 and the surface of the media device 150/250. The substrate 152 can comprise silicon (Si), gallium arsenide (GaAs), or some other semiconductor material. The insulating layer 186 can optionally be included where it is desired that the under-layer 154 be insulated from the substrate 152. The insulating layer 186 can comprise one of an oxide and a nitride material, thereby insulating the media 156/256 from the substrate 152. The under-layer 154 can comprise a highly conductive material that draws heat away from the recording media 156/256 to facilitate fast cooling of the recording media 156/256. The under-layer 154 can comprise tungsten, or alternatively the under-layer 154 can comprise one or more of platinum, gold, aluminum, and copper, or some other material having high conductivity. It may be desired that the material forming the under-layer 154 further be chosen based on additional properties, such as thermal expansion characteristics, adhesion characteristics, and uniformity of deposition, etc.

As can be seen in FIG. 1A, the exemplary media device 150 includes a plurality of cells 187 disposed within an inhibiting matrix 188. The inhibiting matrix 188 can comprise a material that inhibits the flow of current, such as a substantially electrically non-conductive material, or an electrically insulating material, or more specifically a dielectric. It can also be desired that the inhibiting matrix 188 inhibit thermal expansion, and therefore comprise a material that is thermally insulating. The plurality of cells 187 comprise a recording media 156 portion and an over-layer 158 portion. Thus it can be said that the recording media 156 is a discontinuous layer. The recording media 156 can comprise a phase change material such as GST. As the recording media 156 is heated beyond some threshold temperature by driving current from a contact (i.e., a tip 142) through the recording media 156 and then quenched, the structure of some or all of the phase change material in the recording media 156 changes from a crystalline state to a disordered state. Conversely, if the phase change material is heated above some threshold and then allowed to cool slowly, the material will tend to re-crystallize. As a result of the change in structure of the phase change material, the resistivity of the recording media 156 changes. This resistivity change is quite large in phase change materials and can be easily detected by a tip 142 that is conductive or that includes a conductive coating by passing current through the tip 142 and the media device 150.

Further, it can be said that the over-layer 158 is a discontinuous layer. As above, the over-layer 158 can comprise a material selected to prevent physical damage to the recording media 156 and/or to the tip when the tip 142 contacts the over-layer 158. The over-layer 158 can comprise a material that is resistant to wear, thereby extending the lifetime of the over-layer 158 and/or the tip 142. It can be preferable that the over-layer 158 material exhibit wear characteristics similar to wear characteristics of the inhibiting matrix 188 so that undesired non-planarity does not develop through use of the media device 150. The over-layer 158 can comprise a material having a high conductance, such as a conductive metal. The separation of the over-layer 158 by the inhibiting matrix 188 resists shunting of current applied to the over-layer 158, therefore the over-layer 158 need not have low lateral conductivity. However, where desired the over-layer 158 can comprise a material having a low conductance characteristic, and a high hardness characteristic. Alternatively, the over-layer 158 can comprise an anisotropic columnar material that conducts current more readily through a film than across a film, such as a co-deposited film, or some metal nitride such as TiN or MoN having similar properties. Titanium nitride (TiN) is a hard material that conducts poorly.

Alternatively, the over-layer 158 can comprise an insulator. Where an insulator is used as an over-layer 158, current applied to the media device 150 from the tip 142 must tunnel through the over-layer 158 before reaching the recording media 156. Thus, the over-layer 158 is preferably thin (relative to the recording media 156) so that the amount of tunneling required before a current can interact with the recording media 156 is minified. Use of an anisotropic columnar material, or an insulator in the over-layer 158 can be unnecessary because of the isolation of the over-layer 158.

The exemplary media device 150/250 includes a lubricant 151 comprising a continuous film over the surface of the media device 150/250. The lubricant 151 can be formed, deposited, adhered, or otherwise placed, positioned or applied over the surface of the media device 250. The lubricant 151 can be a liquid, or a non-liquid, such as molybdenum disulfide, or alternatively some form of carbon. The lubricant 151 can be applied to the surface of the media device 150/250 using myriad different techniques. For example, the lubricant 151 can be deposited on the surface of the media 150/250 using a deposition process or sprayed onto surface of the media 150/250.

A lubricant adhesion layer 159, for example amorphous carbon, nitrogenated amorphous carbon, hydrogenated amorphous carbon, and DLC, can be disposed between the lubricant 151 and the surface of the media device 150/250. The lubricant 151 is a monolayer comprising a plurality of polymer chains, the polymer chains being adapted to bond to the lubricant adhesion layer 159. Polymer chains can preferentially bond to the lubricant adhesion layer 159 to resist adhesion of the polymer chains to a contact (i.e., the tip 142) or to resist becoming displaced as a result of one or both of friction and stiction. The lubricant adhesion layer 159 provides a uniform surface to which the lubricant 151 can bond.

Patterned media devices such as described herein can be formed using traditional semiconductor manufacturing processes for depositing or growing layers of film in sequence using deposition chambers (e.g., chemical vapor deposition (CVD) chambers, plasma vapor deposition (PVD) chambers) and/or furnaces, for instance. For example, the insulating layer 186, the under-layer 154 are formed over the substrate 152. One of an insulating material and the recording media 156 and over-layer 158 is formed over the stack. Where the insulating material is formed over the stack, the insulated material is patterned and etched to form an inhibiting matrix 188 having vias. The vias are then subsequently filled by successive forming of the recording media material and the over-layer, resulting in the plurality of cells 187. Alternatively as shown in FIG. 1B, where both the recording media and the over-layer are formed over the stack, the recording media and over-layer are patterned and etched to form cells 187. The underlayer 154 not disposed beneath the cells 187 is exposed. A material having insulating properties is deposited or otherwise formed over the exposed underlayer 154, resulting in the inhibiting matrix 188. The surface of the media device 150/250 can be substantially planarized by chemical-mechanical polishing (CMP), for example after deposition steps. A CMP step can planarized the surface of the media device 150/250. The lubricant adhesion layer 159 and the lubricant 151 are then formed over the planarized surface of the media device 150.

Alternatively, the media device 150 can be planarized by dry etching or ion milling rather than CMP. Ion milling can be effectively performed to remove recording media material 156 from the top of the insulating matrix 188. This process has some benefits, for example where GST is the recording media, because of the relatively high selectivity of ion milling processes to oxide/nitride when removing GST. For example, where the aspect ratio of the width to the height of each cell is 1 to 1, the media device 150 can be arranged at an angle of 15 degrees or larger relative to the angle of incidence of the ions that strike the media device 150 during processing. The sidewalls of the cells 187 will mask the GST within the cells 187 from ion bombardment, preventing etching of GST within the cell 187 while removing GST deposited over the inhibiting matrix 188. Ion milling can replace the CMP step following deposition of GST in a via. When the aspect ratio of the width to the height of each cell differs from 1: 1, then the angle between the normal to the surface of the media device 150 and the direction of ion milling beam 390 can be adjusted accordingly to provide protection of the GST deposited in the cavities.

As shown in FIG. 1A, the interface between the inhibiting matrix 188 and the cells 187 is a sidewall having substantially vertical walls. Such substantially vertical walls are formed by an anisotropic etch process, such as by reactive ion etching (RIE). FIG. 1B illustrates an exemplary media device including sidewalls having a slope less than vertical (i.e., approximately 90 degrees) so that the cells 287 taper at the under-layer 154. The width of the cell 287 is about 30 nm on the top (i.e., nearest the cell/tip interface, cell/lubricant, or cell/over-layer interface) and the stack thickness of the cell 287 is about 50 nm, while the pitch between the cells 287 is roughly 50 nm. A minimum sidewall angle can be defined as an angle formed such that the recording media 256 and the under-layer 154 have sufficient electrical contact. Forming sidewalls with tapers in semiconductor structures is known in other technologies to be achievable by a number of different techniques, including nano-imprinting lithography (NIL), reducing photoresist thickness and reducing selectivity to the insulating material.

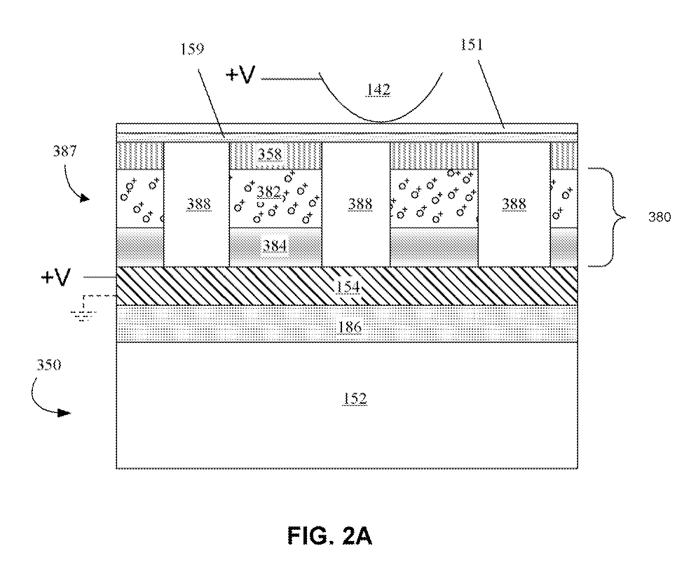

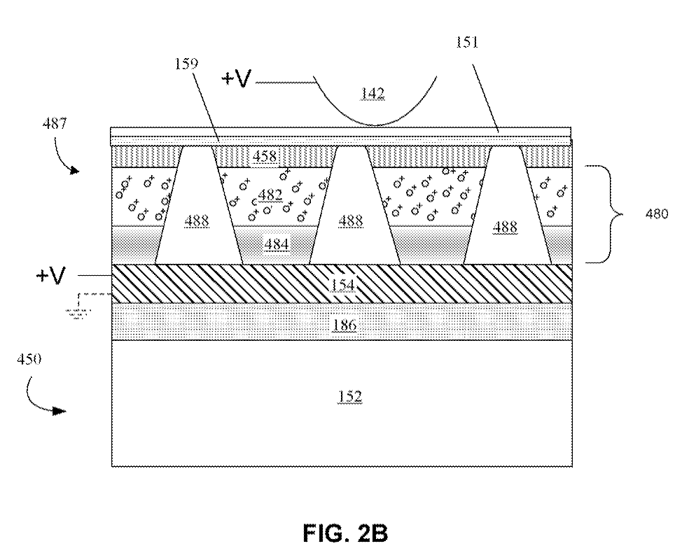

FIGS. 2A and 2B are cross-sections of still further exemplary patterned media devices for use with probe storage devices. Methods in accordance with embodiments of the present invention can be applied to define patterns of the patterned media devices. The exemplary media device 350 includes a plurality of cells 387 disposed within an inhibiting matrix 388 that comprise a polarity-dependent memory layer 380 and a top electrode 358. The plurality of cells 387 and the inhibiting matrix 388 are disposed over a continuous bottom electrode 154. The bottom electrode 154 can comprise one or more of tungsten, platinum, gold, aluminum, and copper. The material can be chosen for forming the bottom electrode 154 based on additional properties, such as adhesion characteristics and uniformity of deposition, etc. Myriad different materials having good electrical conductivity and one or more favorable properties for forming the bottom electrode 154. The bottom electrode 154 provides for good electrical conduction through the polarity-dependent memory layer 380. Much lower currents can be applied to the media device 350 where the polarity-dependent memory layer 380 is used as the recording media, and the material is heated (incidentally) to a lower temperature. The polarity-dependent memory layer 380 is a discontinuous layer that includes an ion source layer 384 and a solid electrolyte layer 382. The polarity-dependent memory layer 380 includes an ion source layer 384 and a solid electrolyte layer 382. Such polarity-dependent memory layers are described, for example, in “Non-Volatile Memory Based Solid Electrolytes” by Kozicki et. al, Proceedings of the 2004 Non-Volatile Memory Technology Symposium, 10-17 (2004), incorporated herein by reference. For the exemplary media device, the ion source layer 384 comprises some metal having mobile ions, such as silver (Ag), or copper (Cu). The solid electrolyte layer 382 is disposed over the ion source layer 384 and in the exemplary media device comprises a metal chalcogenide exhibiting acceptable properties of metal ion mobility within a generally non-conductive matrix, such as silver germanium sulfide (AgGeS), silver germanium selenide (AgGeSe). Alternatively, the solid electrolyte layer 382 can comprise an oxide-based electrolyte such as silver tungsten oxide (AgWO₃) or copper tungsten oxide (CuWO₃). Such materials may or may not exhibit equally satisfactory results comparable to metal chalcogenides. The solid electrolyte layer 382 can be formed after deposition of the ion source layer 384 by depositing a chalcogenide layer such as GeS or GeSe over the ion source layer 384, and applying ultraviolet (UV) light to the material to diffuse Ag ions into the chalcogenide layer. Alternatively, Ag ions can be prompted to diffuse into the chalcogenide layer by annealing. Alternatively, the solid electrolyte layer 382 can comprise a co-deposited film sputtered from separate Ag and GeS or GeSe targets or the solid electrolyte layer 382 can be a co-deposited film sputtered from a single AgGeS or AgGeSe alloy target.

The bottom electrode 154 acts as an anode (i.e., the positive electrode in an electrolytic circuit), and a positive voltage can be applied to the bottom electrode 154, or alternatively the bottom electrode 154 can be grounded. The solid electrolyte layer 382 is disposed over the ion source layer 384. However, the ion source layer 384 can be disposed over the solid electrolyte layer 382.

The top electrode 358 is a discontinuous layer disposed over the polarity-dependent memory layer 380. The top electrode 358 should provide an ion barrier to prevent unintentional migration of ions from the polarity-dependent memory layer 380 into the top electrode 358. As above, the top electrode 358 can comprise a material selected to prevent physical damage to the recording media 380 and/or to the tip 142 when the tip 142 contacts the top electrode 358. The top electrode 358 can comprise a material that is resistant to wear, thereby extending the lifetime of the top electrode 358 and/or the tip 142. The top electrode 358 can comprise a material having a high conductance, such as, for example, a refractory metal (e.g., molybdenum, indium, platinum, iridium and iridium oxide, etc.). However, the class of materials need not necessarily be defined by the maximum temperature of the media device because an indicia in a polarity-dependent memory layer is not exclusively, or typically, a result of a temperature dependent process. The separation of the cells 387 by the inhibiting matrix 388 resists shunting of current applied to the top electrode 358, therefore the top electrode 358 need not comprise a material having low lateral conductivity. However, where desired the top electrode 358 can comprise a material having a low conductance characteristic, and a high hardness characteristic. Alternatively, the top electrode 358 can comprise an anisotropic columnar material that conducts current more readily through a film than across a film, such as a co-deposited film, or some metal nitride such as TiN or MoN having similar properties. Titanium nitride (TiN) is a hard material that conducts poorly.

The media device 350 includes a lubricant 151 comprising a continuous film over the surface of the media device 350. The lubricant 151 can be formed, deposited, adhered, or otherwise placed, positioned or applied over the surface of the media device 350. The lubricant 151 can be a liquid or a non-liquid, such as molybdenum disulfide or a form of carbon.

A lubricant adhesion layer 159, for example amorphous carbon, nitrogenated amorphous carbon, hydrogenated amorphous carbon, and DLC, is disposed between the lubricant 151 and the surface of the media device 350. The lubricant 151 is a monolayer comprising a plurality of polymer chains, the polymer chains being adapted to bond to the lubricant adhesion layer 159. Polymer chains can preferentially bond to the lubricant adhesion layer 159 to resist adhesion of the polymer chains to a contact (i.e., the tip 142) or to resist becoming displaced as a result of one or both of friction and stiction. The lubricant adhesion layer 159 provides a uniform surface to which the lubricant 151 can bond.

Patterned media devices such as described herein can be formed using traditional semiconductor manufacturing processes for depositing or growing layers of film in sequence using deposition chambers (e.g., chemical vapor deposition (CVD) chambers, plasma vapor deposition (PVD) chambers) and/or furnaces, for instance, and etching patterns within selected layers of film to form discontinuous layers. For example, referring to the media device 350 of FIG. 2A, the insulating layer 186 and the bottom electrode 154 are formed over the substrate 152 as continuous layers. One of an insulating material and both the polarity-dependent memory layer 380 and the top electrode 358 is formed over the bottom electrode 154. The polarity-dependent memory layer 380 and the top electrode 358 are formed over the bottom electrode 154. The polarity-dependent memory layer 380 and the top electrode 358 are patterned and etched to form cells 387. The underlayer 154 not disposed beneath the cells 387 is exposed. A material having insulating properties is deposited or otherwise formed over the exposed underlayer 154, resulting in the inhibiting matrix 488. Alternatively, where the insulating material is formed over the bottom electrode 154, the insulated material is patterned and etched to form an inhibiting matrix 388 having vias. The vias are then subsequently filled by successive forming of the polarity-dependent memory layer 380 (which requires multiple processing steps as discussed above) and the top electrode 358 to form the plurality of cells 387. The surface of the media device 350 can be substantially planarized by CMP. The lubricant adhesion layer 159 and the lubricant 151 are then formed over the planarized surface of the media device 350.

As shown in FIG. 2A, the interface between the inhibiting matrix 388 and the cells 387 is a sidewall having a substantially vertical arrangement relative to the planar surface of the media device 350. Such substantially vertical walls are formed by an anisotropic etch process such as by reactive ion etching (RIE). FIG. 2B illustrates an exemplary media device with cell sidewalls having a slope less than vertical (i.e., 90 degrees) so that the cells 487 taper at the bottom electrode 154. For example, the width of the cell 487 is 30 nm on the top (i.e., nearest the cell/tip interface, cell/lubricant, or cell/over-layer interface) and the stack thickness of the cell 487 is 50 nm, while the pitch between the cells 487 is roughly 50 mm. A minimum sidewall angle can be defined as an angle formed such that the recording media 456 and the under-layer 154 have sufficient electrical contact. Forming sidewalls with tapers in semiconductor structures is known in other technologies to be achievable by a number of different techniques, including NIL, reducing photoresist thickness and reducing selectivity to the insulating material.

The patterned media devices described above are merely exemplary, and are meant to show the use of discrete memory cells in data storage. Other patterned media devices used in probe storage devices can use recording media other than a phase change material or a polarity-dependent memory layer. For example, the recording media can be a charge storage-type media. Charge storage media stores data as trapped charges in dielectrics. Thus, for charge storage media, the recording media would be a dielectric material that traps charges when in a written state. Changing media back to an unwritten state simply requires the removal of the trapped charges. For instance, a positive current can be used to store charges in media. A negative current can then be used to remove the stored charges from media.

Defining patterns in media devices requires a technique for delineating features less than 0.1 um in dimension. A class of process techniques known as nano-imprinting lithography (NIL) can be applied to define required patterns for the media devices. Nano-scale alignment may not be required in structures and fabrication methods where NIL process techniques are employed. NIL process techniques can include thermal NIL, ultra-violet (UV) NIL, or step-flash imprinting lithography (SFIL). Such process techniques are capable of resolving features having dimensions smaller than 10 nm, with reasonable throughput at reasonable cost. A template for applying such techniques can be fabricated, for example, with electron beam (“e-beam”) lithography or ion-beam lithography.

Templates with very high counts of nano-features are required for many applications of NIL process techniques. Although fabrication of exemplary media devices has been described in detail above as an application for which NIL process techniques is well suited, applications for which NIL process techniques may be appropriate are not limited to data storage, but rather can include semiconductor manufacturing (where nano-scale alignment is not required), biotechnology, optical components, etc. The number of features on a template is limited by the throughput of modern E-beam lithography tools, many of which are currently limited to approximately 700,000 E-beam flashes per hour. A typical template for a media device as described above can have approximately 10¹¹ features. Creating such a template would require over ten years of E-beam tool time, operating 24 hours a day, seven days a week.

Embodiments of systems and methods in accordance with the present invention can be applied to form templates for use in defining patterns in media devices of probe storage devices. In an embodiment, a mini-master template can be formed comprising a sub-set of the master template and needing a far smaller number of E-beam flashes as compared with the master template. The mini-master can be used to transfer a resulting NIL pattern to a master template by means of NIL lithography. For example, a media device for approximately 1 GB of data storage can be patterned using a hypothetical master template having the following parameters:

| | |
|---|---|
| Memory Cell Pitch | 32 nm |
| Memory Cell Area | 1024 nm² |

Given a contact probe tip arrangement having the following parameters:

| | |
|---|---|
| Single Tip Scan Length | 75 μm |
| Single Tip Scan Area | 5.625 × 10⁹ nm² |

A master template can have 5.49×10⁶ memory cells per tip scan area. Given a tip scan area of this size, approximately 16,700 tips can be employed to achieve the target storage capacity.

Typical E-beam tools productivity is about 7.0×10⁵ flashes per hour. Thus, 7.85 hours of continuous E-beam tool use is required to form the 5.49×10⁶ memory cells of a tip scan area. Under continuous use, a template having 16,700 tip scan areas would require over 10 years of continuous exposure using an E-beam tool to produce the master template.

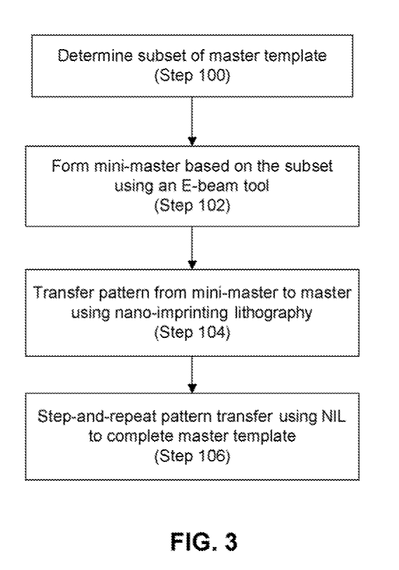

Referring to FIG. 3, an embodiment of a method in accordance with the present invention can include forming a mini-master comprising some fraction of a desired number of tip scan areas. To form the mini-master, a subset of features that are periodically repeated in a master template can be defined (Step 100). The subset of features can then be created as a mini-master using an E-beam tool (Step 102). NIL imprinting can then be repeatedly applied to transfer the mini-master pattern to a master template (Step 104). The mini-master pattern can be applied in a step-and-repeat fashion, similar to stepper lithography. The master template is completed by translating one or both of the mini-master template and the work piece and performing NIL imprint to the mini-master (Step 106).

Because the mini-master comprises a subset of the master template, the master template should be a periodic structure. As described above, exemplary probe storage devices comprise two plates, one of which includes contact probe tips electrically connectable with a patterned media device. Alignment inaccuracy introduced during the step-and-repeat process can be compensated by calibration of the contact probe tips to tracks defined on the patterned media device. Alignment accuracy of stepper lithography equipment is commonly fractions of a micron.

Referring to the example above, a mini-master can be formed having 64 tip scan areas. Such a mini-master would require less than 21 days to expose the mini-master template pattern by using an E-beam tool. The total master template can then be completed by translating the mini-master relative to the master template and making 256 NIL imprints with the mini-master.

Significant savings in time can be achieved by employing NIL imprinting to form a master template for patterned media device processing. However, such a technique should not be construed as being limited to data storage devices as described above. Methods in accordance with the present invention can be used for any other NIL application (data storage, semiconductors, biotechnology, optical components, etc.), provided that the total set of the features to be imprinted possesses translational and/or rotational symmetry and can be reproduced in its entirety by translation and/or rotation of a mini-master sub-template over the imprinted master template substrate.

The foregoing description of the present invention have been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A method of forming a template for use in transferring patterns, the method comprising:
exposing a sub-template using electron beam lithography;
transferring a first pattern from the sub-template using nano-imprinting lithography so that a first portion of the template is formed;
repositioning the sub-template; and
transferring a second pattern from the sub-template using nano-imprinting lithography so that a second portion of the template is formed.

2. The method of claim 1, including transferring a plurality of patterns from the sub-template and repositioning the sub-template after the transfer of each pattern such that the template is formed.

3. The method of claim 1, including electrically connecting the first pattern with the second pattern.

4. The method of claim 2, including electrically integrating the template.

5. The method of claim 1, including aligning the sub-template based on the first pattern so that when transferred, the second pattern is electrically connected with the first pattern.

6. The method of claim 1, wherein the first pattern and the second pattern are the same pattern.

7. A mini-master for building a master template for forming a patterned media, the mini-master comprising:
a pattern having complementary template edges for forming a continuous, repeating structure;
a plurality of alignment tracks within the pattern;
wherein the plurality of alignment tracks enable alignment of a plurality of patterns forming the continuous, repeating structure with a previous pattern.

8. The mini-master of claim 7, wherein the pattern is created using electron beam lithography.

9. A template for forming a patterned media, the template comprising:
a plurality of mini-masters, at least one of the mini-masters including:
a pattern having complementary template edges for forming a continuous, repeating structure;
a plurality of alignment tracks within the pattern;
wherein the plurality of alignment tracks enable alignment of a plurality of patterns forming the continuous, repeating structure with a previous pattern.
